(19) United States
(12) Patent Application Publication
(10) Pub. No.: US 2010/0077626 A1
(43) Pub. Date: Apr. 1, 2010

(54) BIAS RULER

(75) Inventor: Shinichi Kawaguchi, Tokyo (JP)

Correspondence Address: WENDEROTH, LIND & PONACK, L.L.P., 1030 15th Street, N.W.,, Suite 400 East, Washington, DC, 20005-1503, US

(73) Assignee: KAWAGUCHI CO., LTD., Tokyo (JP)

(21) Appl. No.: 12/448,527

(22) PCT Filed: Mar. 27, 2007
(86) PCT No.: PCT/JP2007/056353

§ 371 Date: Jun. 24, 2009

(30) Foreign Application Priority Data
Jan. 5, 2007 (JP) 2007-000021

(51) Int. Cl. B43L 7/00

(52) U.S. Cl. 33/483

(57) ABSTRACT

A bias ruler excellent in practical value, which can draw a bias line simply, accurately and quickly, is excellent in operability and able to draw a bias line easily even on paper or fabric and reduce labor and time required for drawing bias lines at equal or regular intervals. The bias ruler of the present invention includes a transparent or semitransparent long ruler body 1 that has edge portions 3 formed on the longitudinal sides thereof for drawing bias lines, opposite ends in the longitudinal direction thereof used as reference parts 4, and a positioning portion 6 provided with a positioning side 5 and formed to project beyond the end of at least one side of the reference parts 4, wherein the positioning side 5 is formed of a side 7 tapered at about 45 degrees relative to the reference part 4.

### TECHNICAL FIELD

The present invention relates to a bias ruler suitably used as a ruler for fancywork, such as patchwork, for example, and particularly to a bias ruler for drawing bias lines accurately in order to produce a bias tape or bias cut cloth.

### BACKGROUND ART

Various kinds of rulers for drawing bias lines have heretofore been proposed. A bias ruler used particularly as a ruler for fancywork, such as patchwork, is adapted for drawing bias lines in order to prevent fabric fray in performing bias cutting to produce a tape or a triangular or rectangular motif from fabric, thereby necessitating formation of bias fabric or bias cloth. As an example, a ruler which has a rectangular transparent plate provided on one end thereof with a guide line in the shape of the letter “X” forming an angle of 45 degrees and which draw bias lines on fabric, with the guide line and the edge of the fabric overlapped, has been known (Patent Document 1).

Patent Document 1: JP-A 2-9592 (U)

### DISCLOSURE OF THE INVENTION

### Problems the Invention Intends to Solve

In Patent Document 1, since the guide line in the shape of the letter “X” provided on one end of the transparent plate and the edge of fabric are overlapped in order to draw a bias line and, when these have been overlapped, the edge of fabric and a straight portion of the ruler form an angle of 45 degrees, a bias line can be drawn. According to the prior art, when it is intended to draw plural bias lines in parallel, there is a case where the scale marks on the ruler in the longitudinal direction and the bias line already drawn are overlapped. In this case, therefore, the steps necessitated in order to draw a bias line include's displacing the ruler to confirm the position of the bias line already drawn, moving the ruler to a position at which a different bias line is to be drawn, aligning the guide line and the edge of fabric and drawing the different bias line. For this reason, the prior art ruler exhibits poor operability and is inconvenient to handling thereof.

When drawing bias lines at regular intervals, the scales provided on the ruler are utilized. However, since the scales are given aslant relative to the guide line, when drawing a bias line on fabric, a distance has to be measured utilizing the slanted scales. This is difficult to see, inconvenient and necessitates determining an intersection between the slanted lines and the fabric.

Furthermore, when drawing a bias line from an optional position other than the edge of cloth, it is necessary to provide a reference line that is needed to overlap the guide line when drawing a bias line. Also in this case, the steps to be taken are to confirm the position to which the ruler is displaced, align the guide line and reference line and draw a bias line. This is proved to be inferior in operating efficiency.

The present invention has been accomplished in order to solve the problems described above, and the object thereof is to provide a bias ruler excellent in practical value, which can draw a bias line simply, accurately and quickly, is excellent in operability and able to draw a bias line easily even on paper or fabric and reduce labor and time required for drawing bias lines at equal or regular intervals.

### Means for Solving the Problems

To attain the object described above, the present invention set forth in claim 1 provides a bias ruler comprising a transparent or semitransparent long ruler body that has edge portions formed on longitudinal sides thereof for drawing bias lines, opposite ends in a longitudinal direction thereof used as reference parts and a positioning portion provided with a positioning side and formed to project beyond an end of at least one side of the reference parts, wherein the positioning side is formed of a side tapered at about 45 degrees relative to the reference part.

The invention set forth in claim 2 provides the bias ruler, wherein the positioning portion has a shape of rectangular equilateral triangle.

The invention set forth in claim 3 provides the bias ruler, wherein the ruler body has scale display portions, of which visibly discernible nondisplayed regions are disposed at appropriate intervals in an across-the-width region of the ruler body.

The invention set forth in claim 4 provides the bias ruler, wherein the tapered side is provided with a scale portion.

### EFFECTS OF THE INVENTION

According to the invention set forth in claim 1, mere overlapping of the tapered side of the positioning side formed to project beyond the end of the bias ruler and the edge of fabric or a reference line drawn separately enables bias lines to be drawn simply, accurately and quickly and, since the tapered side and the edge of fabric or reference line are merely overlapped, the operability of the bias ruler is excellent and it is possible to reduce labor and time required for drawing plural bias lines accurately.

According to the invention set forth in claim 2, since the positioning side formed to project beyond the end of the bias ruler assumes the shape of rectangular equilateral triangle to form right and left tapered sides both usable appropriately as the situation demands to enable a rapid operation.

According to the invention set forth in claim 3, since of the scale display portions the nondisplayed regions are disposed at appropriate intervals in the across-the-width region, when the bias line and scale marks have been overlapped, the bias line can visibly be discerned below through the nondisplayed regions. Thus, since it is unnecessary to displace the ruler body and confirm the bias line, bias lines can be drawn in parallel rapidly without going to trouble.

According to the invention set forth in claim 4, since the scales are given perpendicularly relative to the tapered side within the shape of rectangular equilateral triangle formed to project beyond the end of the bias ruler, a determination of the reference part made in advance along the scales is very advantageous for drawing bias lines in parallel at regular or equal intervals to enable reduction in time and labor.

### BRIEF DESCRIPTION OF THE DRAWINGS

FIG. 1 is an explanatory plan view showing a state in which bias lines have been drawn on fabric using a bias ruler according to the present invention.

FIG. 2 is a partially enlarged perspective view of the ruler shown in FIG. 1.

FIG. 3 is a plan view of the ruler shown in FIG. 1.

FIG. 4 is an explanatory plan view showing another embodiment of the present invention.

### EXPLANATION OF REFERENCE NUMERALS

1 Ruler body
1a Drawn line side edge part
2 Bias line
3 Drawn line edge part
4 Reference part
4a Reference part end
5 Positioning side
6 Positioning portion
7 Tapered side
8 Scale display portion
9 Nondisplayed region
10 Scale portion
11 Fabric (nondisplayed member)
12 End
13 Scale portion formed on the reference part
14 Roulette device
14a Rotating plate

### BEST MODE FOR CARRYING OUT THE INVENTION

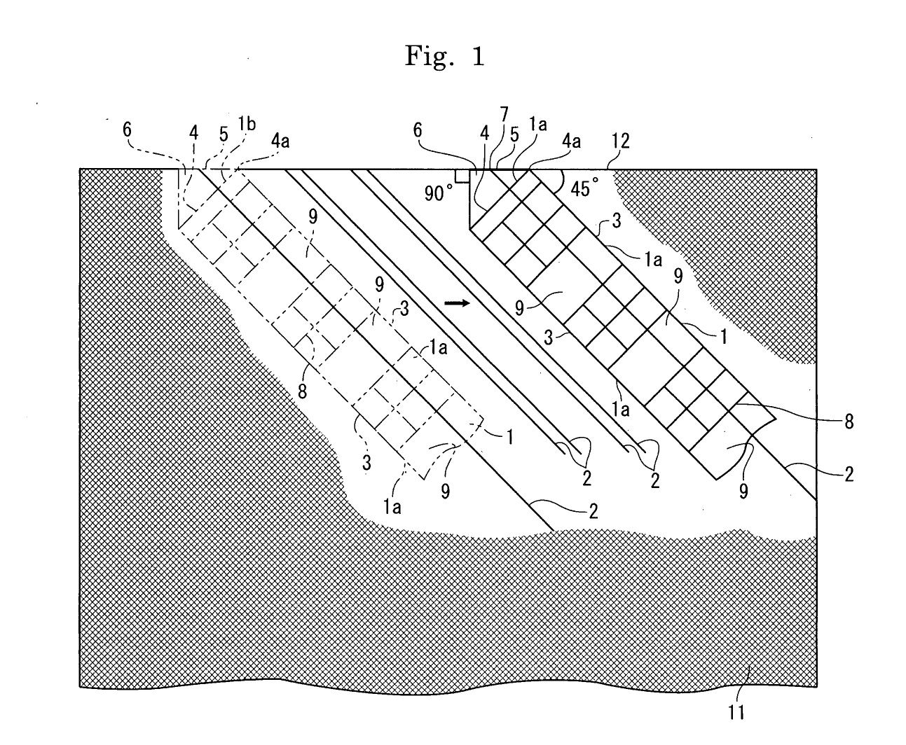

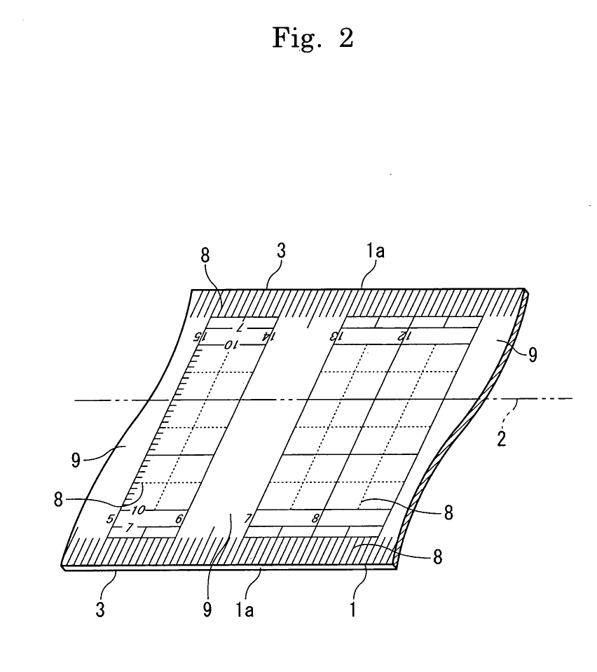

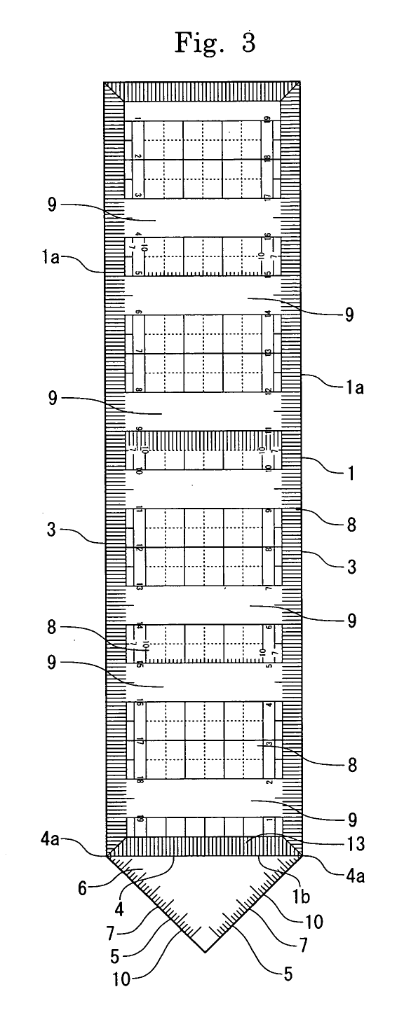

A preferred embodiment of the bias ruler according to the present invention will be described below with reference to the drawings. FIG. 1 is an explanatory plan view showing a state in which bias lines have been drawn on fabric in parallel at regular intervals using the bias ruler, FIG. 2 a partially enlarged perspective view of the bias ruler, and FIG. 3 a plan view of the bias ruler.

In the drawings, reference numeral 1 denotes a ruler body that is a transparent or semitransparent long ruler formed of a resin material and having a structure in which the ruler body 1 has scale display portions 8 and drawn line side edge parts 1a formed along the longitudinal direction, a reference part 4 formed to project beyond the end thereof in the longitudinal direction and provided with a positioning portion 6 and positioning sides 5 that have tapered sides 7, each of which forms an angle of substantially 45 degrees relative to the reference part 4. In addition, the ruler body 1 is provided with across-the-width nondisplayed regions 9 having no display of the scale display portions 8 and disposed at appropriate intervals so as to make the lower surface of the ruler body discernible visibly. Furthermore, the reference part 4 can be formed in the shape of a rectangular equilateral triangle and is configured so that the taper sides 7 of the reference part 4 may be provided with scale portions 10 to enable the distance between adjacent bias lines to be measured.

An end 12 of a piece of fabric 11 (nondisplayed member) is overlapped with the ruler body 1 of the bias ruler according to the present invention, which is adjusted in position so that the positioning side 5 and the end 12 may be overlapped. Otherwise, positioning may be attained by drawing an unshown reference line on the fabric 11 and overlapping the reference line and the positioning side 5. Since the positioning side 5 of the ruler body 1 forms the angle of 135 degrees relative to the drawn line edge part 3, when the positioning side 5 and the end 12 of the fabric 11 have been overlapped, the bias ruler forms a bias line having an angle of 45 degrees and enables the bias line to be drawn on the fabric.

Furthermore, when drawing plural bias lines 2, the aforementioned procedure is used to draw bias lines while sliding the bias ruler 1 to a prescribed position. However, there is a case where the bias line 2 already drawn and any of the longitudinal lines on the scale display portion 8 of the ruler body 1 are overlapped. In this case, bias lines can be drawn accurately and rapidly in the following manner.

To be specific, since the nondisplayed regions 9 are disposed at appropriate intervals on the scale display portion 8 of the bias ruler according to the present invention, the bias line 2 already drawn can visibly be discerned at the lower surface through the nondisplayed regions 9 to enable accurate bias lines 2 to be drawn in parallel rapidly.

When it is desired to draw bias lines 2 at equal or regular intervals, since scale portions 10 perpendicular to the tapered sides 7 are formed inside reference part ends 4a, it is possible to measure the distance using the scale portions 10 and draw the bias lines 2 in parallel rapidly at the equal or regular intervals.

In FIG. 1, the ruler is placed on the fabric on which the bias lines are drawn. However, it may be placed on any material including fabric for a patchwork, paper, etc. insofar as the material is planar. In addition, the place on which the bias ruler abuts in order to draw bias lines is not limited to the end of the fabric. The bias lines can be drawn from a position of the surface of the fabric, on which a line is voluntarily drawn, using the bias ruler of the present invention.

FIG. 2 is a partially enlarged perspective view of the bias ruler. The transparent or semitransparent ruler body 1 is provided with the scale display portions 8 at the positions in the vicinity of the drawn line side edge parts 1a, and the nondisplayed regions 9 are provided at appropriate intervals in the longitudinal direction of the ruler body 1. Conventionally, when drawing plural bias lines, since a ruler and a bias line have been overlapped, the position of the bias line had to be confirmed through the displacement of the ruler. According to the bias ruler of the present invention, however, since the bias line 2 can visibly be discerned through the nondisplayed regions 9 when the bias line 2 and the scale display portions 8 or part of the ruler have been overlapped, it becomes possible to rapidly and accurately draw the bias lines in parallel.

FIG. 3 is a plan view of the bias ruler. The transparent or semitransparent long ruler body 1 is provided with the scale display portions 8 in the longitudinal direction and width directions. The scale display portions 8 are provided with the nondisplayed regions 9 disposed in the width direction at prescribed intervals to secure visible discernibility.

Furthermore, the positioning portion 6 having the positioning sides 5 on one end side of the ruler body is formed to project from the reference part 4, the positioning sides 5 have the tapered sides 7, and the transparent portions inside the projecting part are provided with the scale portions 10. Use of the scale portions 10 enables bias lines to be drawn in parallel at equal or regular intervals.

In FIG. 3, the end 4 having the positioning side 5 is shown on one end side of the ruler. However, it goes without saying that the end may be provided on each of both end sides of the ruler.

Furthermore, the shape of the positioning portion 6 is not limited to the rectangular equilateral triangle; but may comprise a protuberance consisting of the tapered side 7 having an angle of substantially 45 degrees and the positioning side 5 as another embodiment. These are optionally selected depending on the practical use.

As described above, bias lines for cutting bias tapes or rectangular bias cloth used for a patchwork, tapestry preparation, quilting, etc. can accurately be drawn.

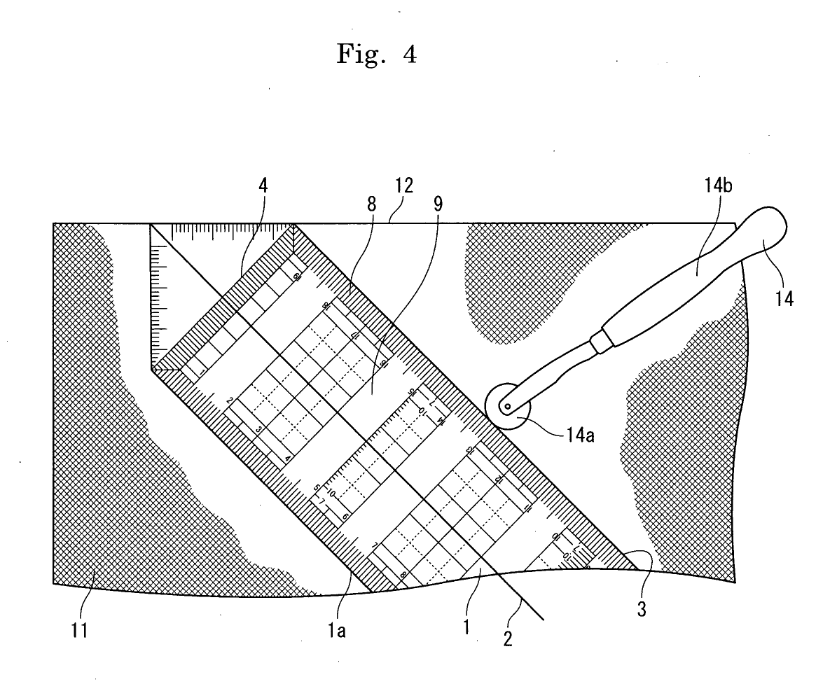

Next, another embodiment shown in FIG. 4 will be described. Here, in the case of forming equilateral-triangular or square bias cloth or preparing a bias tape, for example, a straight bias line of a desired length is drawn from a reference line, a bias line is further drawn from the drawn line and finally a line is drawn toward the reference line. In the case of configurating the equilateral triangle or square in this way, a roulette device 14 is used as shown in FIG. 4. Since the roulette device 14 is provided on the tip thereof with a substantially circular rotating plate 14a attached rotatably to the roulette device 14, lines can be drawn on a piece of fabric. In use, the bias ruler 1 is adjusted to the fabric end 12 to determine a bias angle, then the roulette device 14 is adjusted to the drawn line edge part 3 to move the roulette device 14 along the drawn line edge part thereby rotating the rotating plate 14a to enable bias line to be drawn on the fabric. At this moment, since the bias line 2 already drawn can be confirmed from the nondisplayed region 9 through the bias ruler 1, the bias line 2 drawn using the roulette device 14, even when it has no color, can readily be confirmed.

Furthermore, since the bias ruler of the present invention is made of synthetic resin, such as vinyl chloride, that is a flexible material, though not shown, when one side surface of the ruler body 1 is provided upright as a mount surface, the ruler can be used as being curved and, in this case, the roulette device 14 is used to freely slide the rotating plate 14a thereof, thereby enabling a curved line to be drawn with ease. Incidentally, the bias ruler of the present invention may be formed in an appropriate length of 20 cm, 40 cm, etc. and inch indication may be substituted for the cm indication. These are optionally selected depending on the practical use.

1. A bias ruler comprising a transparent or semitransparent long ruler body that has edge portions formed on longitudinal sides thereof for drawing bias lines, opposite ends in a longitudinal direction thereof used as reference parts and a positioning portion provided with a positioning side and formed to project beyond an end of at least one side of the reference parts, wherein the positioning side is formed of a side tapered at about 45 degrees relative to the reference part.

2. A bias ruler according to claim 1, wherein the positioning portion has a shape of rectangular equilateral triangle.

3. A bias ruler according to claim 1, wherein the ruler body has scale display portions, of which visibly discernible nondisplayed regions are disposed at appropriate intervals in an across-the-width region of the ruler body.

4. A bias ruler according to claim 1, wherein the tapered side is provided with a scale portion.

5. A bias ruler according to claim 2, wherein the ruler body has scale display portions, of which visibly discernible nondisplayed regions are disposed at appropriate intervals in an across-the-width region of the ruler body.

6. A bias ruler according to claim 2, wherein the tapered side is provided with a scale portion.

7. A bias ruler according to claim 3, wherein the tapered side is provided with a scale portion.
